(19) United States
(12) Patent Application Publication
(10) Pub. No.: US 2021/0064662 A1
(43) Pub. Date: Mar. 4, 2021

(54) DATA COLLECTION SYSTEM FOR EFFECTIVELY PROCESSING BIG DATA

(71) Applicant: AhP-Tech Inc., Taipei City (TW)

(72) Inventor: CHAO-HUANG CHEN, TAIPEI CITY (TW)

(21) Appl. No.: 16/655,742

(22) Filed: Oct. 17, 2019

(30) Foreign Application Priority Data
Aug. 30, 2019 (TW) 108131430

(51) Int. Cl. G06F 16/9035; G06F 16/906

(52) U.S. Cl. CPC G06F 16/9035; G06F 16/906

(57) ABSTRACT

A data collection system for effectively processing big data is introduced. The data collection system includes multiple risk filtering modules up to second order or higher and a specific data extractor, wherein the multiple risk filtering modules and the specific data extractor are connected in series. The data collection system is capable of filtering received raw data through the multiple risk filtering modules so as to filter out raw data with security risks, and obtaining required raw data by the specific data extractor. Accordingly, the system may assist the user automatically to carefully select raw data with high usability, so as to enhance convenience and security of data collection effectively.

### CROSS-REFERENCE TO RELATED APPLICATION

This non-provisional application claims priority under 35 U.S.C. § 119(a) on Patent Application No. 108131430 filed in Taiwan, R.O.C. on Aug. 30, 2019, the entire contents of which are hereby incorporated by reference.

### BACKGROUND OF THE INVENTION

### 1. Field of the Invention

The invention relates to a data collection system, and particularly to a data collection system for effectively processing big data.

### 2. Description of the Related Art

With the rapid expansion of the Internet, it is full of various sources of information (various websites and web pages), and as the number of websites and web pages increases, the amount of data existing on the Internet also grows faster than expected. Accordingly, the collection tool for extracting materials from big data is produced.

Currently, most of the collection tools for specific big data adopt filtering methods with keywords or combination of rules. For the data collection systems, required to extract desired results from the exploding amounts of data of the information sources, there are issues of a large amount of computational resource consumption, or of the filtering results with mutual interference due to excessive rules or keywords. In addition, it is easy for the traditional filtering methods with keywords or rules to collect a lot of malicious data or data out of the usable extents. Such situations not only consume computing resources in vain, but also cause information security concerns.

Thus, it is desirable to have improvement on the collection tools of the conventional art.

### BRIEF SUMMARY OF THE INVENTION

In view of the above-mentioned deficiency of the conventional art, the main objective of the present invention is to provide a data collection system that effectively processes big data, which not only is capable of selecting required raw data from received raw data, but also filtering out the raw data with different properties and security concerns. Accordingly, the system can assist users in selecting raw data with high usability so as to effectively enhance the convenience and security of data collection.

In order to achieve the above objective, the data collection system comprises:

a first-order risk filtering module, for receiving a plurality of raw data;

a second-order risk filtering module; and

a specific data extractor,

wherein the first-order risk filtering module, the specific data extractor and the second-order risk filtering module are connected in series, so as to filter out raw data with security risks and extract required raw data, and accordingly the data collection system outputs usable raw data.

The data collection system according to the invention is capable of filtering received raw data through the first-order and second-order risk filtering modules so as to filter out raw data which is undesirable or has risks such as security concerns or so on, and obtaining required raw data by the specific data extractor. Accordingly, the system may assist the user automatically to carefully select raw data with high usability, so as to achieve the advantage of effective enhancement of convenience and security of data collection.

### BRIEF DESCRIPTION OF THE DRAWINGS

FIG. 1 is a schematic architecture diagram illustrating a first preferred embodiment of a data collection system according to the invention.

FIG. 2 is a schematic architecture diagram illustrating a second preferred embodiment of the data collection system according to the invention.

FIG. 3 is a schematic architecture diagram illustrating a third preferred embodiment of the data collection system according to the invention.

FIG. 4 is a schematic architecture diagram illustrating a preferred embodiment of a first-order risk filtering module according to the invention.

FIG. 5 is a schematic architecture diagram illustrating a preferred embodiment of a personal information detection module according to the invention.

FIG. 6 is a schematic architecture diagram illustrating a preferred embodiment of a second-order risk filtering module according to the invention.

FIG. 7 is a schematic architecture diagram illustrating a preferred embodiment of a third-order risk filtering module according to the invention.

FIG. 8 is a schematic architecture diagram illustrating a preferred embodiment of a visible data output module according to the invention.

FIG. 9 is a schematic architecture diagram illustrating a preferred embodiment of a system device according to the invention.

### DETAILED DESCRIPTION OF THE INVENTION

To facilitate understanding of the object, characteristics and effects of this present disclosure, embodiments together with the attached drawings for the detailed description of the present disclosure are provided.

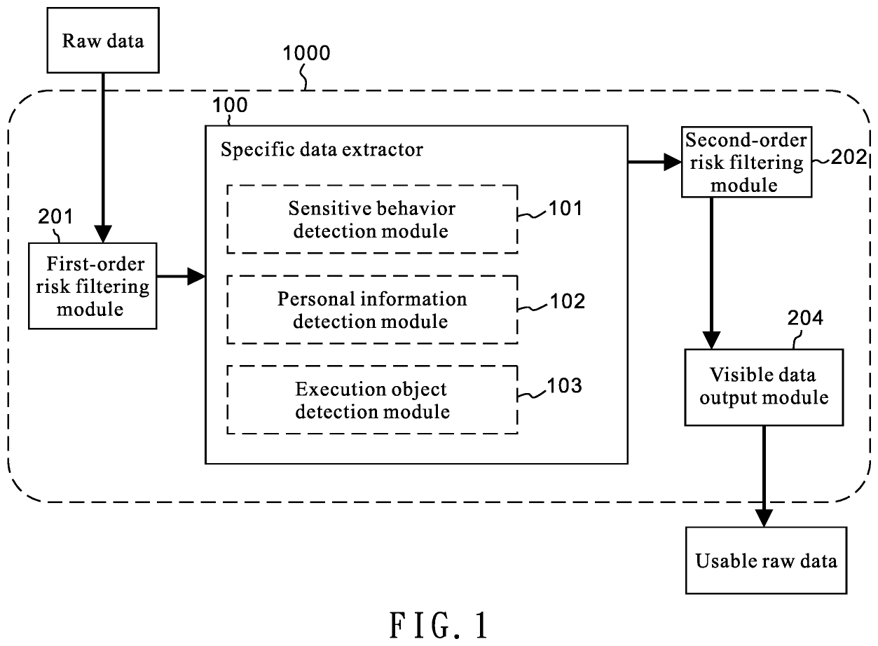

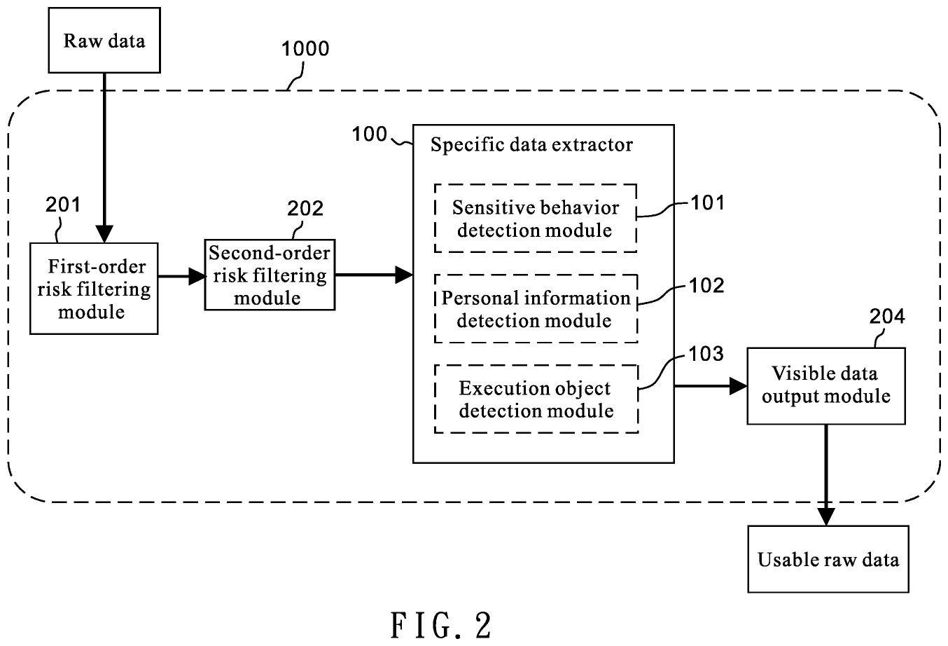

Referring to FIG. 1, a data collection system for effectively processing big data is illustrated according to a preferred embodiment of the invention. As shown in FIG. 1, the data collection system 1000 comprises a specific data extractor 100, a first-order risk filtering module 201 and a second-order risk filtering module 202. The specific data extractor 100, the first-order risk filtering module 201 and the second-order risk filtering module 202 are connected in series, for example, in this embodiment, in the order of the first-order risk filtering module 201, the specific data extractor 100, the second-order risk filtering module 202 sequentially. In a preferred embodiment, the specific data extractor 100, the first-order risk filtering module 201 and the second-order risk filtering module 202 can be connected in the order of the first-order risk filtering module 201, the second-order risk filtering module 202, the specific data extractor 100 sequentially (as shown in FIG. 2). In another preferred embodiment, the second-order risk filtering module 202 may be connected before the first-order risk filtering module 201, and the invention is not limited thereto.

The first-order risk filtering module 201 is utilized for receiving a plurality of raw data, and filtering and/or screening the raw data, initially filtering the raw data with security concerns so as to prevent the data collection system 1000 from generating security vulnerability. The raw data may include a plurality of contents (such as text, video, images, executable objects, or so on) from one or more remote hosts, and the invention is not limited thereto.

The specific data extractor 100 receives the raw data filtered by the first-order risk filtering module 201, and further extracts and/or selects required raw data from the filtered raw data. In the present preferred embodiment, the specific data extractor 100 includes a sensitive behavior detection module 101, a personal information detection module 102 and an execution object detection module 103. The sensitive behavior detection module 101 is utilized to extract the raw data associated with sensitive behavior. The personal information detection module 102 is utilized to extract the raw data associated with personal information, such as user accounts, email address book or so on. The execution object detection module 103 is employed to extract the raw data that is executable, such as EXE files, Java Script or so on.

The second-order risk filtering module 202 filters the received raw data, so as to filter out the raw data which is undesirable or has risks such as security concerns or so on.

Hence, the data collection system 1000 is capable of filtering received raw data through multiple risk filtering modules up to second order or higher (e.g., the first-order and second-order risk filtering modules) so as to filter out raw data which is undesirable or has risks such as security concerns or so on, and obtaining required raw data by the specific data extractor. Accordingly, the data collection system 1000 may assist the user automatically to carefully select raw data with high usability, so as to achieve the advantage of effective enhancement of convenience and security of data collection.

In the present preferred embodiment, the data collection system 1000 further includes a visible data output module 204, which receives the raw data resulted from the filtering of the risk filtering modules and the extracting of the specific data extractor 100, and generates an integrated report after performing classification, normalization, regression analysis, principle component analysis, data clustering analysis, and visualization outputting on the received raw data. In this manner, the user can quickly and clearly obtain analysis results of the raw data with practical value.

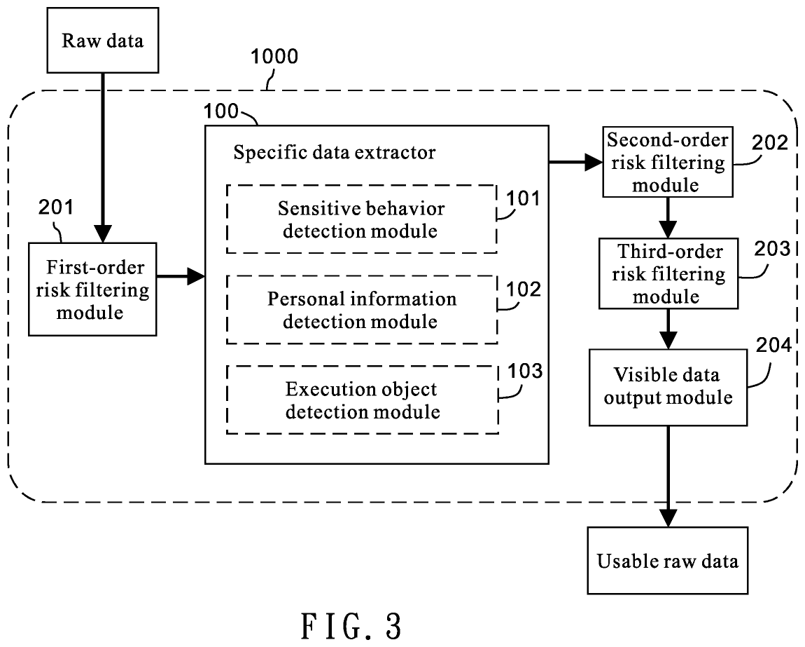

In the present preferred embodiment, the data collection system 1000 further includes a third-order risk filtering module 203. Referring to FIG. 3, the third-order risk filtering module 203 can be configured to be between the second-order risk filtering module 202 and the visible data output module 204. The third-order risk filtering module 203 is utilized for filtering received raw data so as to filter out raw data which is undesirable or has risks such as security concerns or so on, and outputs the filtered raw data to the visible data output module 204 so as to improve the usability of the filtered raw data effectively.

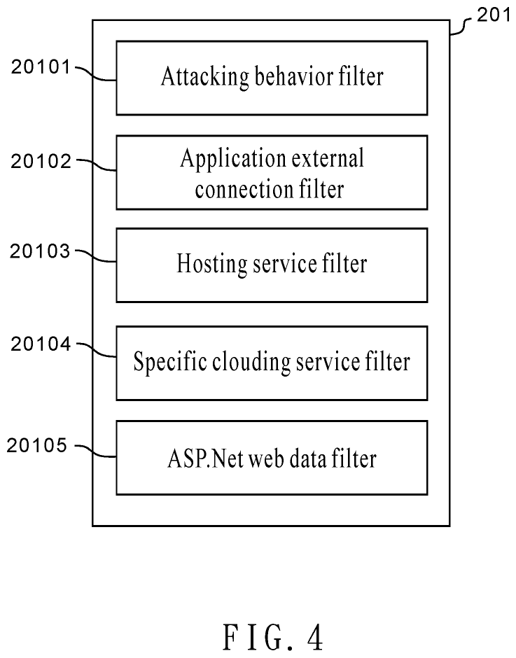

Referring to FIG. 4, the first-order risk filtering module 201 of the preferred embodiment is illustrated for the sake of description. As shown in FIG. 4, the first-order risk filtering module 201 further includes an attacking behavior filter 20101, an application external connection filter 20102, a hosting service filter 20103, a specific clouding service filter 20104 and an ASP.Net web data filter 20105.

The attacking behavior filter 20101 is employed to filter the raw data with attacking behavior, so as to prevent the data collection system 1000 from generating security vulnerability, wherein the attacking behavior may be, for example, a web injection attack, a cross-site scripting (XSS) attack or so on. The application external connection filter 20102 is utilized to filter the raw data with application program specific external connections so as to prevent internal data from being maliciously transmitted to external devices and causing security vulnerability of the data collection system 1000. The hosting service filter 20103 is used to filter the data packets of the raw data belonging to a specific hosting service. The specific clouding service filter 20104 is utilized for filtering data packets of the raw data related to a specific clouding service implemented by Java Applet, so as to avoid the security vulnerability of the specific clouding service causing security vulnerability of the data collection system 1000. The ASP.Net web data filter 20105 is employed to filter the raw data regarding specific webpage data implemented using ASP.Net. In this way, the first-order risk filtering module 201 is capable of filtering out the raw data with security concerns, thus not only protecting the data collection system 1000, but also effectively extracting the usable raw data.

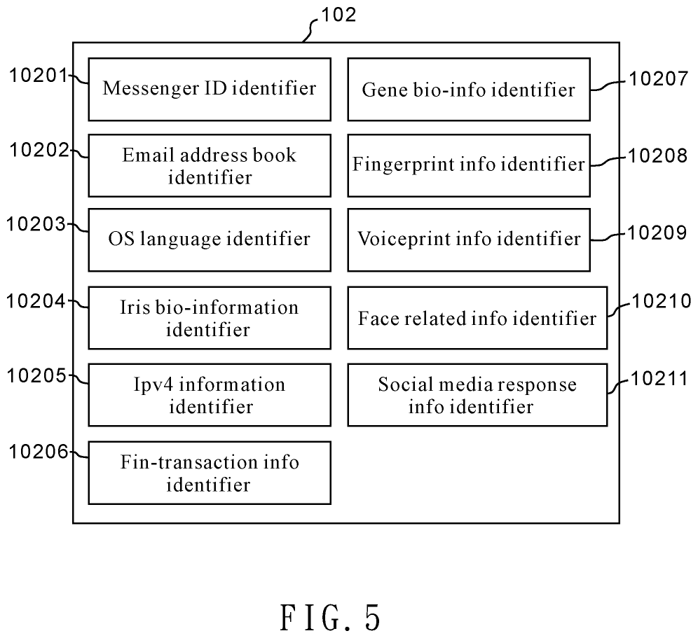

Referring to FIG. 5, the personal information detection module 102 of the preferred embodiment is illustrated for the sake of description. As shown in FIG. 5, the personal information detection module 102 further includes a messenger ID identifier 10201, an email address book identifier 10202, an OS language identifier 10203, an iris bio-information identifier 10204, an IPv4 information identifier 10205, a fin-transaction info identifier 10206, a gene bio-info identifier 10207, a fingerprint info identifier 10208, a voiceprint info identifier 10209, a face related info identifier 10210, and a social media response info identifier 10211.

The messenger ID identifier 10201 is used to identify and extract the raw data related to user accounts of communication software (e.g., LINE). The email address book identifier 10202 is used to identify the raw data related to an email address book. The OS language identifier 10203 is used to identify the language of the operating system of the source of the raw data. The iris bio-information identifier 10204 is used to identify the raw data related to biological information of iris. The IPv4 information identifier 10205 is used to identify the IPv4 information of the device of the data source of the raw data. The fin-transaction info identifier 10206 is used to identify the raw data related to financial transaction. The gene bio-info identifier 10207 is used to identify the raw data related to biological information of genes. The fingerprint info identifier 10208 is used to identify the raw data related to biological information of fingerprints. The voiceprint info identifier 10209 is used to identify the raw data related to biological information of voiceprints. The face related info identifier 10210 is used to identify the raw data related to biological information of faces. The social media response info identifier 10211 is used to identify the raw data related to return data from social media (e.g., FaceBook®). In this manner, the personal information detection module 102 can quickly and accurately extract the raw data associated with personal information and being usable so as to improve the efficiency of data collection processing, thus enhancing the convenience of data collection.

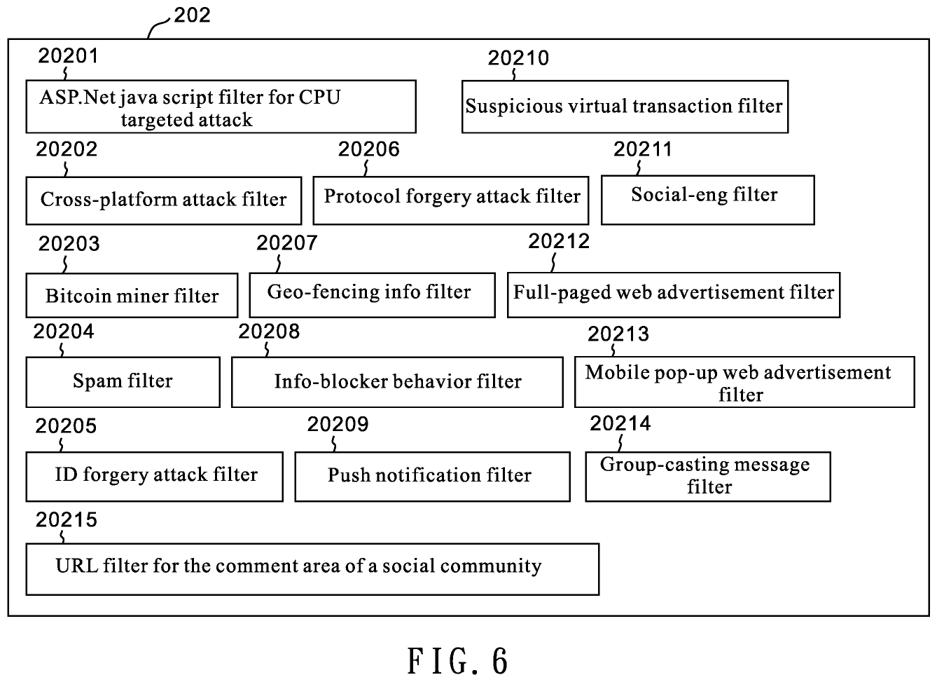

Referring to FIG. 6, the second-order risk filtering module 202 of the preferred embodiment is illustrated for the sake of description. As shown in FIG. 6, the second-order risk filtering module 202 further includes an ASP.Net Java script filter 20201 for CPU targeted attack, a cross-platform attack filter 20202, a bitcoin miner filter 20203, a spam filter 20204, an ID forgery attack filter 20205, a protocol forgery attack filter 20206, a geo-fencing info filter 20207, an info-blocker behavior filter 20208, a push notification filter 20209, a suspicious virtual transaction filter 20210, a social-eng filter 20211, a full-paged web advertisement filter 20212, a mobile pop-up web advertisement filter 20213, a group-casting message filter 20214 and a URL filter 20215 for the comment area of a social community.

The ASP.Net java script filter 20201 for CPU targeted attack filters the raw data related to a JavaScript for attacking a CPU as an attack target, to prevent internal information of the data collection system 1000 from being stolen, causing security vulnerability of the data collection system 1000. The cross-platform attack filter 20202 filters the raw data related to a cross-platform attack, for example, a remote Trojan program, to avoid the theft of control authority for the control data collection system 1000, causing security vulnerability of the data collection system 1000. The bitcoin miner filter 20203 is capable of filtering, but not limited to, the raw data related to a bitcoin miner script hidden in a webpage, to avoid unauthorized malicious access to computational resources of the data collection system 1000, causing additional resource consumption of the data collection system 1000. The spam filter 20204 is utilized for filtering spam in a data stream, for example, advertising emails, to reduce the computational burden of the data collection system 1000 and improve the usability of the filtered raw data. The ID forgery attack filter 20205 filters the raw data related to an ID forgery attack. The protocol forgery attack filter 20206 filters the raw data related to a protocol forgery attack. The geo-fencing info filter 20207 filters the raw data related to geographical fencing information. The info-blocker behavior filter 20208 filters the raw data related to a data stream for performing information blocker, to prevent the data collection system 1000 from collecting incorrect raw data, thus reducing the resource consumption of the data collection system 1000. The push notification filter 20209 filters the raw data transmitted by a push notification server, to prevent the data collection system 1000 from collecting undesirable raw data, thus reducing the resource consumption of the data collection system 1000. The suspicious virtual transaction filter 20210 is employed to filter the raw data related to suspicious virtual transaction, to prevent the data collection system 1000 from collecting undesirable or incorrect raw data, for example, raw data related to illegal behavior, thus reducing the resource consumption of the data collection system 1000. The social-eng filter 20211 filters the raw data belonging to social engineering, to prevent the data collection system 1000 from collecting undesirable or incorrect raw data, for example, raw data related to fraudulent behavior, thus reducing the resource consumption of the data collection system 1000. The full-paged web advertisement filter 20212 is utilized for filtering, but not limited to, the raw data related to a pop-up full-page web advertisement, thus reducing the resource consumption of the data collection system 1000. The mobile pop-up web advertisement filter 20213 is intended for filtering the raw data belonging to a pop-up advertisement of a mobile phone, thus reducing the resource consumption of the data collection system 1000. The group-casting message filter 20214 is intended for filtering the raw data related to group messages sent by communication software (e.g., Line@). Since the group messages sent by communication software are usually advertisement or promotional messages, the group-casting message filter 20214 can be employed to prevent the data collection system 1000 from collecting undesirable or incorrect raw data, thus reducing the resource consumption of the data collection system 1000. The URL filter 20215 for the comment area of a social community is intended for filtering the raw data related to uniform resource locators (URL) posted in a comment area of a social community, to prevent the data collection system 1000 from collecting undesirable or incorrect raw data, thus reducing the resource consumption of the data collection system 1000.

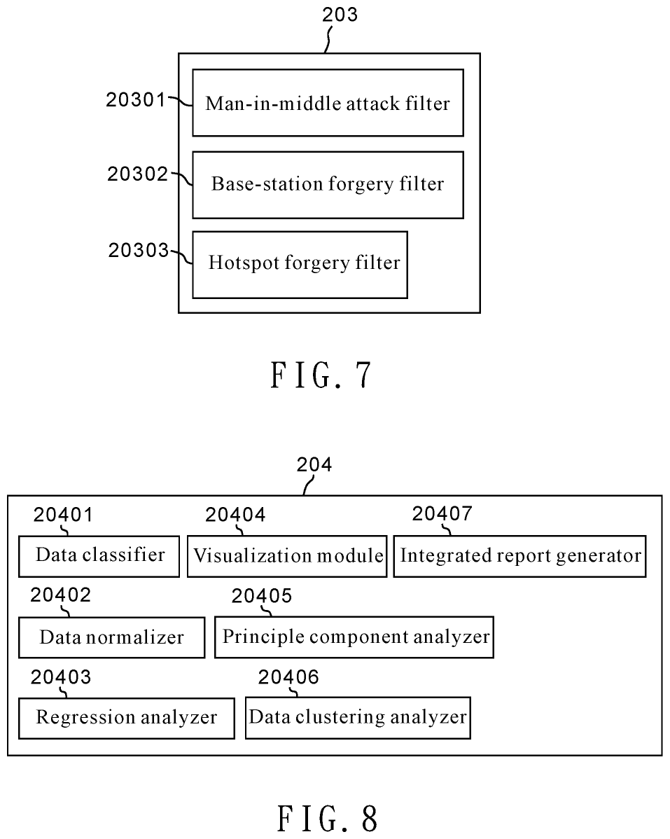

Referring to FIG. 7, the third-order risk filtering module 203 of the preferred embodiment is illustrated for the sake of description. As shown in FIG. 7, the third-order risk filtering module 203 further includes a man-in-middle attack filter 20301, a base-station forgery filter 20302 and a hotspot forgery filter 20303. The man-in-middle attack filter 20301 filters the raw data related to data packets used by a man-in-middle attack. The base-station forgery filter 20302 filters the raw data related to packets sent by a fake base station. The hotspot forgery filter 20303 filters the raw data related to packets sent by a fake hotspot. Thus, the data collection system 1000 is prevented from collecting undesirable or incorrect raw data, thus reducing the resource consumption of the data collection system 1000.

Referring to FIG. 8, the visible data output module 204 of the preferred embodiment is illustrated for the sake of description. As shown in FIG. 8, the visible data output module 204 further includes a data classifier 20401, a data normalizer 20402, a regression analyzer 20403, a visualization module 20404, a principal components analyzer 20405, a data clustering analyzer 20406 and an integrated report generator 20407. The data classifier 20401 is capable of classifying collected raw data according to the user's setting. The data normalizer 20402 performs normalization on the classified raw data, to reduce data redundancy and enhance data consistency. The regression analyzer 20403 performs regression analysis on the normalized raw data. The visualization module 20404 makes visualization output, such as generating charts, based on the raw data which is analyzed above. The principle component analyzer 20405 performs principle component analysis (PCA) on the collected raw data. The data clustering analyzer 20406 analyzes the collected raw data according to various algorithms to determine whether there is a certain cluster distribution. The integrated report generator 20407 generates an integrated report based on the collected raw data, the results of at least one of the above analyses, and the visualization output.

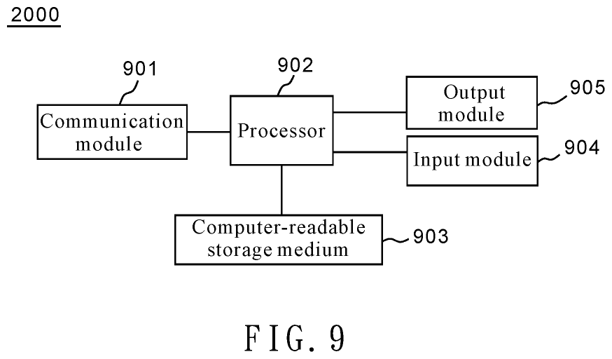

In the present preferred embodiment, the data collection system 1000 may be implemented by a system device, such as, an embedded system device platform, a user computer or a server host or so on. In another embodiment, the data collection system 1000 may be implemented by a cloud server; and the invention is not limited to the above examples. Referring to FIG. 9, a system device 2000 for the preferred embodiment is illustrated. As shown in FIG. 9, the system device 2000 at least includes a communication module 901, a processor 902, a computer-readable storage medium 903, an input module 904 and an output module 905, wherein the processor 902 and the communication module 901, the computer-readable storage medium 903, the output module 905 and the input module 904 are connected electrically. The communication module 901 is utilized to receive the raw data from an external website or webpage; the communication module 901 may be implemented by a communication circuit compliant with a serial port protocol, a wireless communication protocol or any protocol; and the invention is not limited the above examples. The computer-readable storage medium 903 can store at least one program to perform the data collection system 1000, and may be implemented by a non-volatile memory such as a flash memory; and the invention is not limited thereto. The processor 902 is employed to read and execute the at least one program, and may be implemented by one or more processors. The input module 904 is capable of receiving setting or an instruction inputted by a user using an external input device (e.g., mouse, keyboard, touch monitor or so on) to configure the data collection system 1000 correspondingly. The output module 905 is utilized to output the integrated report generated by the execution of the program to a display device. In this manner, the user can view the usable raw data conveniently and readily through the integrated report shown by the display device.

To sum up, the data collection system according to the invention as exemplified and described above is capable of automatically filtering received raw data through multiple risk filtering modules up to second order or higher (e.g., the first-order and second-order risk filtering modules) so as to filter out raw data which is undesirable or has risks such as security concerns or so on, and obtaining required raw data selected by the specific data extractor. Accordingly, the data collection system may quickly and safely assist the user to carefully select raw data with high usability, so as to achieve the advantage of effective enhancement of convenience and security of data collection.

While the present disclosure has been described by means of specific embodiments, numerous modifications and variations could be made thereto by those skilled in the art without departing from the scope and spirit of the present disclosure set forth in the claims.

What is claimed is:

1. A data collection system for effectively processing big data, the data collection system comprising:
a first-order risk filtering module, for receiving a plurality of raw data;
a second-order risk filtering module; and
a specific data extractor,
wherein the first-order risk filtering module, the specific data extractor and the second-order risk filtering module are connected in series, so as to filter out raw data with security risks and extract required raw data, and accordingly the data collection system outputs usable raw data.

2. The data collection system according to claim 1, wherein the specific data extractor comprises a sensitive behavior detection module, a personal information detection module and an execution object detection module.

3. The data collection system according to claim 2, wherein the personal information detection module comprises a messenger ID identifier, an email address book identifier, an OS language identifier, an iris bio-information identifier, an IPv4 information identifier, a fin-transaction info identifier, a gene bio-info identifier, a fingerprint info identifier, a voiceprint info identifier, a face related info identifier and a social media response info identifier.

4. The data collection system according to claim 1, wherein the first-order risk filtering module comprises an attacking behavior filter, an application external connection filter, a hosting service filter, a specific clouding service filter and an ASP.Net web data filter.

5. The data collection system according to claim 1, wherein the second-order risk filtering module comprises an ASP.Net java script filter for CPU targeted attack, a cross-platform attack filter, a bitcoin miner filter, a spam filter, an ID forgery attack filter, a protocol forgery attack filter, a geo-fencing info filter, an info-blocker behavior filter, a push notification filter, a suspicious virtual transaction filter, a social-eng filter, a full-paged web advertisement filter, a mobile pop-up web advertisement filter, a group-casting message filter and a URL filter for the comment area of a social community.

6. The data collection system according to claim 1, the data collection system further comprises a third-order risk filtering module, which is connected to the second-order risk filtering module in sequence.

7. The data collection system according to claim 6, wherein the third-order risk filtering module comprises a man-in-middle attack filter, a base-station forgery filter and a hotspot forgery filter.

8. The data collection system according to claim 1, wherein the data collection system further comprises a visible data output module.

9. The data collection system according to claim 8, wherein the visible data output module comprises a data classifier, a data normalizer, a regression analyzer, a visualization module, a principle component analyzer, a data clustering analyzer and an integrated report generator.

10. The data collection system according to claim 1, wherein the data collection system is a cloud server, an embedded system device platform, a user computer or a server host.
